(19) United States
(12) Patent Application Publication
(10) Pub. No.: US 2013/0151818 A1
(43) Pub. Date: Jun. 13, 2013

(54) MICRO ARCHITECTURE FOR INDIRECT ACCESS TO A REGISTER FILE IN A PROCESSOR

(71) Applicants: Erez Barak, Tel-Aviv (IL); Alejandro Rico Carro, Barcelona (ES); Jeffrey H. Derby, Research Triangle Park, NC (US); Amit Golander, Tel-Aviv (IL); Omer Heymann, Tel-Aviv (IL); Nadav Levison, Tel-Aviv (IL); Sagi Manole, Tel-Aviv (IL); Robert K. Montoye, Yorktown Heights, NY (US)

(72) Inventors: Erez Barak, Tel-Aviv (IL); Alejandro Rico Carro, Barcelona (ES); Jeffrey H. Derby, Research Triangle Park, NC (US); Amit Golander, Tel-Aviv (IL); Omer Heymann, Tel-Aviv (IL); Nadav Levison, Tel-Aviv (IL); Sagi Manole, Tel-Aviv (IL); Robert K. Montoye, Yorktown Heights, NY (US)

(73) Assignee: International Business Machines Corporation, Armonk, NY (US)

(21) Appl. No.: 13/323,933

(22) Filed: Dec. 13, 2011

(51) Int. Cl. G06F 9/30; G06F 9/38

(52) U.S. Cl. 712/208; 712/E09.016; 712/E09.045

(57) ABSTRACT

A method and system for improving performance and latency of instruction execution within an execution pipeline in a processor. The method includes finding, while decoding an instruction, a pointer register used by the instruction; reading the pointer register; validating a pointer register entry; reading, if the pointer register entry is valid, a register file entry; validating a register file entry; validating, if the register file entry is invalid, a valid register file entry wherein the valid register file entry is in the register file's future file; bypassing, if the valid register file entry is valid, a valid register file value from the register file's future file to the execution pipeline wherein the valid register file value is in the valid register file entry; and executing the instruction using the valid register file value; wherein at least one of the steps is carried out using a computer device.

### BACKGROUND OF THE INVENTION

1. Field of the Invention

The present invention relates to register files and, more particularly, to managing a register file within an indirection architecture.

2. Description of Related Art

A register file is an array of processor registers in a central processing unit (CPU). Register files are employed by a processor or execution unit to store various data intended for manipulation.

Performance of a processor/execution unit can generally be improved by increasing the number of registers within the processor. Indirection is a technique that has been used to access large register files at the expense of complicating a CPU's processing pipeline. As a result, current indirection methods raise the risk of hazards which reduce the CPU efficiency.

### SUMMARY OF THE INVENTION

Accordingly, one aspect of the present invention provides a method improving performance and latency of instruction execution within an execution pipeline in a processor is provided. The method includes the steps of: finding, while decoding an instruction, a pointer register used by the instruction; reading the pointer register; validating a pointer register entry in the pointer register; reading, if the pointer register entry is valid, a register file entry in a register file wherein the register file entry is referenced by the pointer register entry; validating a register file entry; validating, if the register file entry is invalid, a valid register file entry wherein the valid register file entry is in the register file's future file; bypassing, if the valid register file entry is valid, a valid register file value from the register file's future file to the execution pipeline wherein the valid register file value is in the valid register file entry; and executing the instruction using the valid register file value; wherein at least one of the steps is carried out using a computer device so that performance and latency of instruction execution within the execution pipeline in the processor is improved.

Another aspect of the present invention provides a method of improving performance and latency of instruction execution within an execution pipeline in a processor. The method includes the steps of improving performance and latency of instruction execution within an execution pipeline in a processor, the method comprising the steps of: finding, while decoding an instruction, a pointer register used by the instruction; reading the pointer register; validating a pointer register entry in the pointer register; validating, if the pointer register entry is invalid, a valid pointer register entry wherein the valid pointer register entry is in the pointer register's future file; bypassing, if the valid pointer register entry is valid, a valid pointer register value from the pointer register's future file to the execution pipeline wherein the valid pointer register value is in the valid pointer register entry; reading a register file entry in a register file wherein the register file entry is referenced by the valid pointer register value; validating the register file entry; and executing, if the register file entry is valid, the instruction; wherein at least one of the steps is carried out using a computer device so that performance and latency of instruction execution within the execution pipeline in the processor is improved.

Another aspect of the present invention provides a system for improving performance and latency of instruction execution within an execution pipeline in a processor. The system includes a decode module, where the decode module is adapted to (i) interpret an instruction and (ii) find a pointer register which is dependent on a previous instruction where the pointer register is used by the instruction; a pointer register module, where the pointer register module is adapted to (i) read a pointer register file, (ii) determine whether a pointer register value is valid and (iii) determine whether a valid pointer register value is in a pointer register's future file; a register file module, where the register file module is adapted to (i) read a register file entry referenced by a pointer register value, (ii) determine whether a register file value is valid and (iii) determine whether a valid register file value is in a register file's future file; a bypass module, where the bypass module is adapted to bypass data to another location from either (i) a register file's future file or (ii) a pointer register's future file; and a pipeline module, where the pipeline module is adapted to either stall or flush the instruction.

### BRIEF DESCRIPTION OF THE DRAWINGS

FIG. 1 is a diagram of an exemplary method of managing a register file according to a preferred embodiment of the present invention.

FIG. 2 is system diagram for managing a register file according to a preferred embodiment of the present invention.

### DETAILED DESCRIPTION OF THE PREFERRED EMBODIMENTS

Using registers instead of system memory for data manipulations has many advantages. For example, registers can typically be designated by fewer bits in instructions than locations in system memory require for addressing. In addition, registers have higher bandwidth and shorter access time than most system memories. Furthermore, registers are relatively straightforward to design and test. Thus, modern processor architectures tend to have a relatively large number of registers. Indirect access to a register file in a processor can provide a number of benefits such as (a) enabling the use of very large architected register files, in particular without expanding the size of register-operand fields in instruction formats; (b) providing dynamic addressability of data elements contained in the register file; and (c) when employed in a SIMD architecture, significantly extending the range of algorithms for which SIMD provides a valuable performance advantage.

However, having a large number of registers presents several problems. One of these problems is register addressability. If a processor includes a large number of addressable registers, each instruction having one or more register designations would require many bits to be allocated solely for the purpose of addressing registers. For example, if a processor has 32 registers, a total of 20 bits are required to designate four registers within an instruction because five bits are needed to address all 32 registers. Thus, the maximum number of registers that can be directly accessed within a processor architecture is effectively constrained.

Indirection is a technique that has been used to circumvent this architectural constraint in order to access large register files. Indirect access to a register file in a processor can provide a number of benefits such as (a) enabling the use of very large architected register files, in particular without expanding the size of register-operand fields in instruction formats; (b) providing dynamic addressability of data elements contained in the register file; and (c) when employed in a SIMD architecture, significantly extending the range of algorithms for which SIMD provides a valuable performance advantage.

Processor architectures that have proposed to use large register files with indirect access include the eLite DSP architecture and the SIMD PowerPC architecture, an enhanced and extended version of VMX. For an overview of large register file technology, refer to: (1) Moreno et al., “An innovative low-power high-performance programmable signal processor for digital communications”, IBM Journal of Research and Development Vol. 47, No 2/3, 2003, (2) Derby et al., “A high-performance embedded DSP core with novel SIMD features,” Acoustics, Speech, and Signal Processing, 2003 Proceedings (ICASSP '03) 2003, (3) U.S. Pat. No. 7,596,680, (4) Derby et al., “VICTORIA: VMX indirect compute technology oriented towards in-line acceleration”, Proceedings of the 3rd conference on Computing frontiers, May 3-05, 2006, (5) U.S. Pat. No. 7,360,063, (6) “Rotating Registers”, Intel Itanium™ Architecture Software Developer's Manual, Part II, 2.7.3, October 2002, (7) Tyson et al., “Evaluating the Use of Register Queues in Software Pipelined Loops”, IEEE Trans. on Computers, vol. 50, No. 8, August 2001, (8) Kiyohara et al., “Register Connection: A New Approach To Adding Registers Into Instruction Set Architectures”, Computer Architecture, 1993, Proceedings of the 20th Annual International Symposium on Computer Architecture, May, 1993 and (9) US Patent Application Publication Number 2003/0191924.

However, indirection has many challenges with managing “hazards” when processing instructions. Instructions in a pipelined processor are performed in several stages, so that at any given time multiple instructions are processed at various stages of the pipeline. There are many different instruction pipeline microarchitectures, and instructions may be executed out-of-order. A hazard occurs when two or more of these simultaneous (possibly out of order) instructions conflict.

For example, when an instruction B depends on the result of a predecessor instruction A, instruction B can use an old and incorrect register file value. This can occur if the register file was not updated with instruction A's updated result before instruction B retrieved the value from the register file. The use of indirection further complicates this issue. Indirection adds an abstraction layer between an instruction and the register file which makes it more difficult to determine which register file entries are actually used by any given instruction. This makes it more difficult to determine whether instruction B is dependent on a predecessor instruction A. This data latency is one of many hazards that can occur.

Mechanisms typically employed to avoid hazard conditions such as this include dependency checking (i.e. determining if a new instruction entering the pipeline depends on the results of instructions that have not yet completed), bypasses around the register file, and stalling (i.e. preventing the instruction from proceeding through the pipeline until all instructions on which it depends have reached the point where their results will be correctly available).

Future files are also used in some architectures. Future files are additional register files which are updated as soon as the instructions finish as opposed to the architectural (sequential) register file which is updated later. In other words, the future file reflects the future with respect to the architectural file and is used for computation by the functional units. Instructions are issued and results are returned to the future file in any order. There is also a reorder buffer that receives results at the same time they are written into the future file. When the head pointer finds a completed instruction (a valid entry), the result associated with that entry is written in the architectural file.

Given the current state of the prior art, there is a need to modify the contents of pointer registers with minimum latency, even given the degree of interaction between the pointer registers and the main register file outlined above, while effectively detecting potential hazards. Consequently, it would be desirable to provide an improved method for managing registers which will increase a CPU's efficiency in executing instructions while effectively handling hazards. In particular, modification of the contents of pointer registers must take place with minimum latency, even given the degree of interaction between the pointer registers and the main register file, and at the same time the mechanism for detecting potential hazards must be effective, even given the need to identify and read the contents of the pointer registers to be used by an instruction.

The present invention is described below with reference to flowchart illustrations and/or block diagrams of methods and apparatus (systems) according to embodiments of the invention. The present invention addresses requirements on the microarchitecture used to implement the indirection and pointer-register management. For any instruction the indirection must be resolved, i.e. the identity of the actual registers to be read or written by the instruction must be known, in order for hazards to be detected.

In an embodiment of the present invention, an indirection architecture as above is used. More particularly, the indirection architecture is implemented in the context of a processor with a pipeline structure with one or more of the following stages: instruction decode, dependency checking, register file read, execution and register write and completion. In addition, pointer registers are incorporated into architecture which provides dynamic addressability of data elements contained in the main register file. The use of pointer register entries to identify registers in the main register file to be accessed by an instruction is described in the references above (where the term “map registers” is used to refer to pointer registers). The use of pointer register entries to address individual data elements contained in the main register file, e.g. when this register file supports subword parallelism, is described the references above. The references also teach the use of “increment registers,” which are used by instructions to increment the entries in pointer registers with absolute minimum latency.

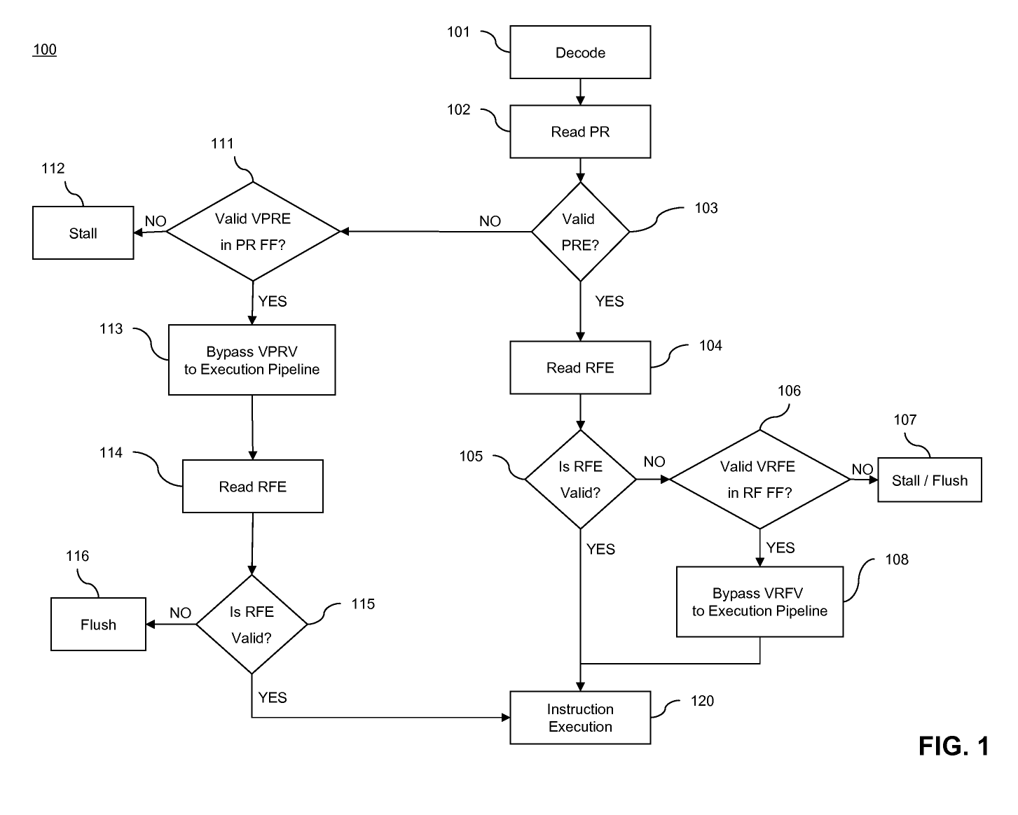

FIG. 1 is a flow chart illustrating a method 100 of improving performance and latency of instruction execution within an execution pipeline in a processor according to a preferred embodiment of the present invention. In a typical processor, an instruction traverses a pipeline as it is decoded. The instruction's input operands are fetched from registers; the instruction is executed; the instruction's result is generated, and the result is written to a register and committed to the processor's architected state. Since the pipeline generally has several stages, there will be several clock cycles between decode of an instruction and writeback of its result to the register file.

Entries in register-operand fields in an instruction may be used as indices into a special set of registers called “pointer registers”, and the appropriate entries in the pointer registers are used to identify the registers in the main register file to be accessed by the instruction. A pointer register may be an operand of an instruction, with the entries in the register used to address data elements contained in the main register file, e.g. to gather them into a target register in the main register file. The management of the pointer registers is under software control. There are also instructions that can set the entries in a pointer register using an immediate value in the instruction, and instructions that can set the entries in a pointer register by copying entries from a register in the main register file.

At step 101, an instruction is decoded. During the decoding step 101, pointer registers that are used by the instruction are found so that the information available at the output of the decode step includes the names of the registers in the main register file to be accessed by the decoded instruction. These pointer registers can be dependent on previous instructions previously placed into the pipeline. In addition, all increment registers and associated increment processes related to the instruction can also determined during the decoding step 101.

The pointer registers found in step 101 are used to determine which pointer registers (“PR”) are read in step 102. For each PR that is read in step 102, there is a valid bit and a “pointer” to the last instruction that writes to it. In step 103, the pointer register entry (“PRE”) is validated. PREs can be validated by checking whether (1) the pointer register's valid bit is set or not or (2) a valid pointer register entry (“VPRE”) exists in the pointer register's future file (“PR FF”).

### Workflow for Valid Pointer Register Entries

If the PRE is valid there is no outstanding instruction in the pipeline that writes to PR. In this case, the instruction safely read the register file entry (“RFE”) in step 104 using the pointer register entry read in step 102.

For each RFE that is read in step 104, there is a valid bit and a “pointer” to the last instruction that writes to it. In step 105, the RFE can be validated by checking (1) whether the RFE's valid bit is set or not or (2) whether a valid register file entry (“VRFE”) exists in the register file's future file. It should be noted that determining whether a VRFE exists in the register file's future file can be done in step 105 instead of step 106, since the existence of a VRFE in the register file's future file is a method of validating a VFRE.

If the RFE's valid bit is set or if no VRFE is found in the register file's future file, the RFE is valid and there is no outstanding instruction in the pipeline that writes to it. In this case, the instruction can continue safely to instruction execution in step 120.

If the RFE is invalid, step 106 determines whether a valid VRFE exists in the register file's future file by determining whether (1) a VRFE exists in the register file's future file (“RF FF”) and (2) the VRFE's valid bit has been set. If the VRFE's valid bit has not been set, or a VRFE has not been found in the file register's future file, then the instruction is either stalled or flushed in step 107. If a valid VRFE exists in the register file's future file, then the VRFV within the valid VRFE is bypassed, in step 108, from the register file's future file to the execution pipeline. After the bypass in step 108 occurs, the VRFE found in step 106 is used instead of the RFE read in step 104 when executing the instruction in step 120.

### Workflow for Invalid Pointer Register Entries

If the PRE is invalid, it is not possible at this stage in the pipeline to run the dependency check in step 105 using the contents of the pointer register read in step 102 because the pointer register's contents are not available. Instead, an optimistic decision is made that the presence of a hazard is unlikely, and the instruction proceeds to step 111.

Step 111 determines whether a valid VPRE exists in the pointer register's future file by determining whether (1) a VPRE exists in the pointer register's future file (“PR FF”) and (2) the VPRE's valid bit has been set. It should be noted that determining whether a VPRE exists in the pointer register's future file can be done in step 103 instead of step 111, since the existence of a VPRE in the pointer register's future file is a method of validating a pointer register entry.

If the VPRE's valid bit has not been set, or a VPRE has not been found in the pointer register's future file, then the instruction is stalled in step 112. If a valid VPRE exists in the pointer register's future file, then the VPRV within the valid VPRE is bypassed, in step 113, from the pointer register's future file to the execution pipeline. After the bypass in step 113 occurs, the VPRE found in step 111 is used instead of the PR read in step 102 when determining which RFE to read in step 114.

For each RFE that is read in step 114, there is a valid bit and a “pointer” to the last instruction that writes to it. In step 115, the RFE can be validated by checking (1) whether the RFE's valid bit is set or not or (2) whether a valid register file entry (“VRFE”) exists in the register file's future file. If the RFE's is valid, there is no outstanding instruction in the pipeline that writes to the RFE. In this case, the instruction can continue safely to step 120 in order to execute the instruction. If RFE is invalid, then the instruction is flushed in step 116 and the instruction is restarted at the head of the pipeline.

It should be noted that stalling the instruction at step 116 is usually not possible since the bypass of the VPRV has delayed the process to a point where the instruction has reached the register-file-read stage of the pipeline. In other words, the check done in step 115 is identical to the check done in step 105, except that the check done in step 115 is executed later in the cycle compared to the check done in step 105 due to the need to wait for the bypass of the VPRV value in step 113.

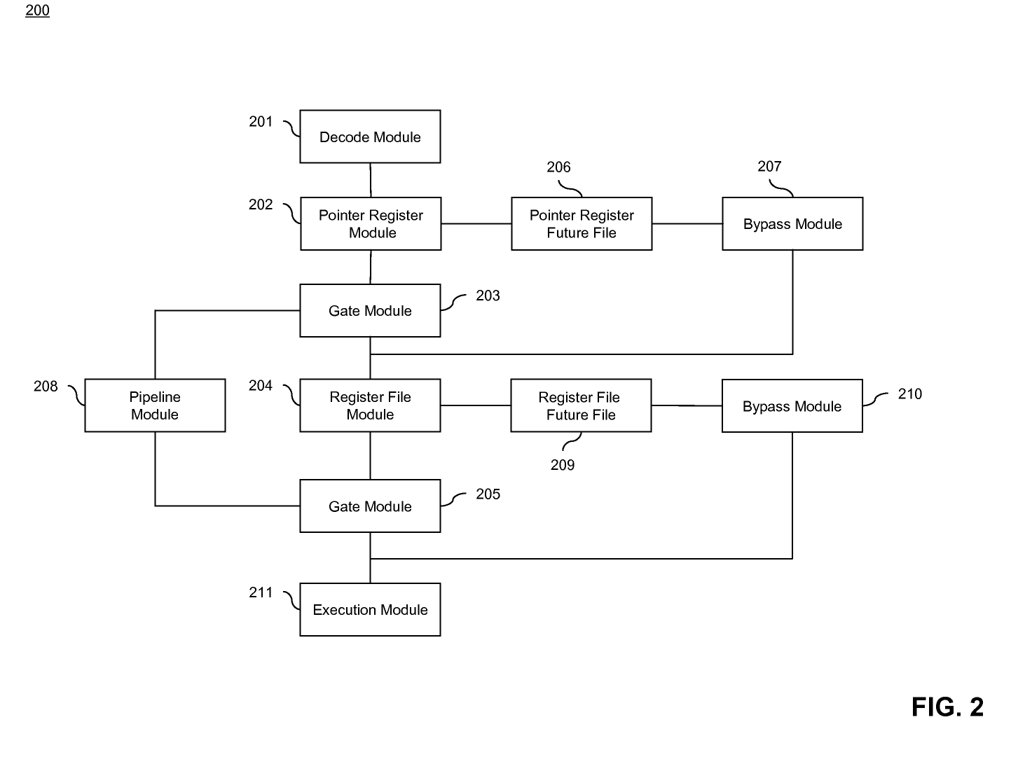

FIG. 2 shows a system 200 for improving performance and latency of instruction execution within an execution pipeline in a processor according to a preferred embodiment of the present invention. The system 200 includes a decode module 201 which interprets an instruction and determines which pointer register entries are used by the instruction. This determination is done so that the information available at the output of the decode step includes the names of the registers in the main register file to be accessed by the decoded instruction. In addition, the decode module determines all increment registers and associated increment processes related to the instruction.

In the preferred embodiment shown in FIG. 2, system 200 includes a pointer register module 202 which (1) reads a pointer register, (2) validates a pointer register entry and (3) validates a valid pointer register entry. Validation of the PRE/VPRE can be done by checking (1) whether the PRE/VPRE valid bit is set or (2) whether a VPRE exists in the pointer register's future file.

Similarly, in the preferred embodiment shown in FIG. 2, system 200 includes a register file module 204 which (1) reads a register file based on pointer registers read by the pointer register module 202, (2) validates a register file entry and (3) validates a valid register file entry in the register file's future file 209. Validation of the RFE/VRFE can be done by checking (1) whether the RFE/VRFE valid bit is set or (2) whether a VFRE exists in the register file's future file.

In the preferred embodiment shown in FIG. 2, system 200 also includes bypass modules 207 and 210. Bypass module 207 bypasses values from the pointer register future file 206 to the execution pipeline. Bypass module 210 bypasses values from the register file future file 209 to the execution pipeline. It should be noted that although FIG. 2 represents bypass modules 207 and 210 as two modules, modules 207 and 210 can be encompassed in a single bypass module as well.

In the preferred embodiment shown in FIG. 2, system 200 also includes gate modules 203 and 205. Gate 203 passes an instruction from the pointer register module 202 to either the pipeline module 208 or the register file module 204. Gate 205 passes an instruction from the register file module 204 to either the pipeline module 208 or the execution module 211. It should be noted that although FIG. 2 represents gate modules 203 and 205 as two modules, modules 203 and 205 can be encompassed in a single gate module as well.

In the preferred embodiment shown in FIG. 2, system 200 also includes a pipeline module 208. Pipeline module 208 either stalls or flushes an instruction in the pipeline.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of improving performance and latency of instruction execution within an execution pipeline in a processor, the method comprising the steps of:
finding, while decoding an instruction, a pointer register used by said instruction;
reading said pointer register;
validating a pointer register entry in said pointer register;
reading, if said pointer register entry is valid, a register file entry in a register file wherein said register file entry is referenced by said pointer register entry;
validating a register file entry;
validating, if said register file entry is invalid, a valid register file entry wherein said valid register file entry is in said register file's future file;
bypassing, if said valid register file entry is valid, a valid register file value from said register file's future file to the execution pipeline wherein said valid register file value is in said valid register file entry; and
executing said instruction using said valid register file value;
wherein at least one of the steps is carried out using a computer device so that performance and latency of instruction execution within the execution pipeline in the processor is improved.

2. The method according to claim 1, further comprising the step of stalling or flushing said instruction if said valid register file entry is invalid.

3. The method according to claim 1 wherein said validating said pointer register entry step comprises the step of determining whether a valid bit in said pointer register entry is set.

4. The method according to claim 1 wherein said validating said pointer register entry step comprises the step of determining whether a valid pointer register entry is in said pointer register's future file.

5. The method according to claim 1 wherein said validating a register file entry step comprises the step of determining whether a valid bit in said register file entry is set.

6. The method according to claim 1 wherein said validating a register file entry step comprises the step of determining whether said valid register file entry is in said register file's future file.

7. The method according to claim 1 wherein said validating a valid register file entry step comprises the step of determining whether a valid bit in said valid register file entry is set.

8. A method of improving performance and latency of instruction execution within an execution pipeline in a processor, the method comprising the steps of:
finding, while decoding an instruction, a pointer register used by said instruction;
reading said pointer register;
validating a pointer register entry in said pointer register;
validating, if said pointer register entry is invalid, a valid pointer register entry wherein said valid pointer register entry is in said pointer register's future file;
bypassing, if said valid pointer register entry is valid, a valid pointer register value from said pointer register's future file to said execution pipeline wherein said valid pointer register value is in said valid pointer register entry;
reading a register file entry in a register file wherein said register file entry is referenced by said valid pointer register value;
validating said register file entry; and
executing, if said register file entry is valid, said instruction;
wherein at least one of the steps is carried out using a computer device so that performance and latency of instruction execution within the execution pipeline in the processor is improved.

9. The method according to claim 8 further comprising the step of flushing said instruction if said register file entry is invalid.

10. The method according to claim 8 further comprising the step of stalling said instruction if said valid pointer register entry is invalid.

11. The method according to claim 8 wherein said validating said pointer register entry step comprises the step of determining whether a valid bit in said pointer register entry is set.

12. The method according to claim 8 wherein said validating said pointer register entry step comprises the step of determining whether a valid pointer register entry is in said pointer register's future file.

13. The method according to claim 8 wherein said validating said valid pointer register entry step comprises the step of determining whether a valid bit in said valid pointer register entry is set.

14. The method according to claim 8 wherein said validating said register file entry step comprises the step of determining whether a valid bit in said register file entry is set.

15. The method according to claim 8 wherein said validating said register file entry step comprises the step of determining whether a valid register file entry is in said register file's future file.

16. A system for improving performance and latency of instruction execution within an execution pipeline in a processor, the system comprising:
a decode module, wherein said decode module is adapted to (i) interpret an instruction and (ii) find a pointer register which is used by said instruction;
a pointer register module, wherein said pointer register module is adapted to (i) read a pointer register file, (ii) validate a pointer register value (iii) validate a valid pointer register value;
a register file module, wherein said register file module is adapted to (i) read a register file entry referenced by a pointer register value, (ii) validate a register file value and (iii) validate a valid register file value;
a bypass module, wherein said bypass module is adapted to bypass data to said execution pipeline; and
a pipeline module, wherein said pipeline module is adapted to either stall or flush said instruction.

17. A system according to claim 16 further comprising an instruction execution module, wherein said instruction execution module is adapted to execute said instruction.

18. A system according to claim 16 further comprising a gate module, wherein said gate module is adapted to direct said instruction to said pipeline module, said register file module or said execution module.

19. A system according to claim 16 wherein said pointer register module validates said pointer register value by determining whether a valid bit in said pointer register is set.

20. A system according to claim 16 wherein said register file module validates said register file value by determining whether a valid bit in said register file entry is set.
